(19) United States
(12) Patent Application Publication
(10) Pub. No.: US 2004/0179711 A1
(43) Pub. Date: Sep. 16, 2004

(54) Speaker having a weight ring

(76) Inventors: Joon-Ho Park, Kyungsangnam-do (KR); Gyeong-Jun Nam, Busan-city (KR)

Correspondence Address: Alan B. Clement, Esq., HEDMAN & COSTIGAN, P.C., 1185 Avenue of the Americas, New York, NY, 10036, US

(21) Appl. No.: 10/796,803

(22) Filed: Mar. 9, 2004

(30) Foreign Application Priority Data
Mar. 13, 2003 (KR) 2003-0015630

(51) Int. Cl. H04R 1/00; H04R 9/06; H04R 11/02

(52) U.S. Cl. 381/412; 381/400; 381/423

(57) ABSTRACT

The speaker comprises a ring-shaped frame 110, a magnetic circuit section 120, a vibration section 130, a terminal 140, a tinsel wire 145, and a weight ring 150. The ring-shaped frame 110 has a through hole formed in the center of thereof. The magnetic circuit section 120 is coupled to the outside of the through hole. The vibrating section 130 include a diaphragm 131 with an upper end coupled to the inner side of the through hole at the upper side of the frame 110, and a voice coil 133 having an upper end coupled to the diaphragm 131 and a lower end located in the magnetic circuit section 120. The tinsel wire 145 has one end connected to the terminal 140 and the other end connected to the voice coil 133. The weight ring 150 is coupled to the outer surface of the voice coil 133. With this configuration, the weight ring coupled to the voice coil allows the weight of the voice coil 133 to be increase. Accordingly, the voice coil 133 has a large amplitude in a low frequency band, and then the efficiency of the low-pitched sound range may be enhanced.

### BACKGROUND OF THE INVENTION

1. Field of the Invention

The present invention relates to a speaker, and more particularly, to a speaker having a weight ring coupled to a voice coil so as to increase an amplitude of the voice coil in a low frequency band.

2. Description of the Prior Art

A conventional speaker will be below described with reference to accompanying drawings. FIG. 1 is a sectional view showing a conventional speaker.

As shown in the FIG. 1, the conventional speaker 1 comprises a ring-shaped frame 10 having a through hole formed in the center portion thereof. A magnetic circuit section 20 generating a magnetic force is coupled to an outside of the frame 10 at the position of the through hole. The magnetic circuit section 20 comprises a yoke 21, a magnet 23 and a plate 25.

A vibrating section 30 is provided in an interior of the frame 10. The vibrating section 30 has a diaphragm 31 and a voice coil 33. An upper end of the diaphragm 31 is coupled to an upper side of the frame 10. The voice coil 33 has an upper end coupled to the diaphragm 31, and a lower end coupled to the inner side of the magnetic circuit section 20, for vibrating in vertical directions by interaction with the magnetic circuit section 20 when a power is supplied.

The voice coil 33 is connected to a terminal 40 provided in one side of the frame 10 by means of a tinsel wire 45. When an external power is supplied to the voice coil 33 through the terminal 40, the voice coil 33 is vibrated by interaction with the magnetic circuit section 20. The diaphragm 31 is vibrated in accordance with vibration of the voice coil 33, so the sound wave is generated from the diaphragm 31.

In such a conventional speaker, however, the voice coil 33 may be vibrated by its self-weight. Thus, there is a problem that the efficiency of the low-pitched sound is deteriorated since the amplitude of the voice coil 33 is to be reduced in a low frequency band.

Furthermore, the tinsel wire 45 may be contacted to the diaphragm 31 when the diaphragm 31 is vibrated by the voice coil 33, since the tinsel wire 45 is closely adjacent to the diaphragm 31. Thus there is another problem that a noise is generated.

### SUMMARY OF THE INVENTION

Accordingly, the present invention has been made to solve the above-mentioned problems occurring in the prior art, and an object of the present invention is to provide a speaker having a weight ring which is coupled to a voice coil capable of increasing an amplitude of a voice coil in a low frequency band, and preventing the tinsel wire from being contacted with the diaphragm vibrated by the voice coil.

In order to accomplish this object, there is provided a speaker comprising: a ring-shaped frame having a through hole formed in the center of thereof; a magnetic circuit section coupled to the outside of the through hole, for generating a magnetic force; a vibrating section including a diaphragm with an upper end coupled to the inner side of the through hole at the upper side of the frame, and a voice coil having an upper end coupled to the diaphragm and a lower end located in the magnetic circuit section, for vibrating the diaphragm by interaction with the magnetic circuit section when a power is supplied; a terminal formed to one side of the frame to be connected with an external power; a tinsel wire having one end connected to the terminal and the other end connected to the voice coil, for providing the power from the external power to the voice coil; and a weight ring coupled to the outer surface of the voice coil, for increasing an amplitude of the voice coil when the voice coil is vibrated, and for prohibiting the tinsel wire from contacting the diaphragm when the diaphragm is vibrated by the voice coil.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view of a conventional speaker;

FIG. 2 is a sectional view of a speaker according to an embodiment of the present invention; and

FIG. 3 is a perspective view of a weight ring according to an embodiment of the present invention.

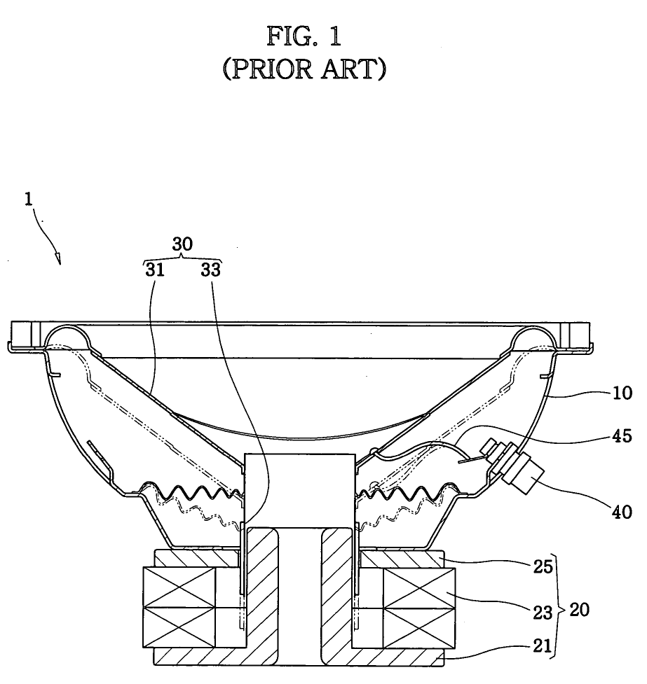

### DESCRIPTION OF THE PREFERRED EMBODIMENTS

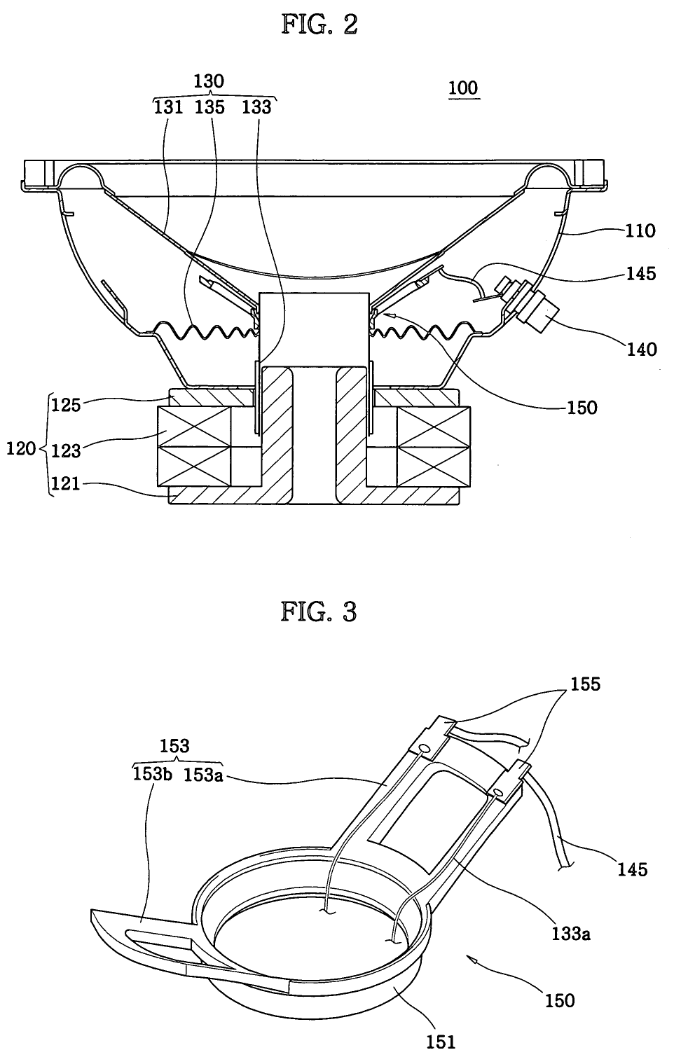

Hereinafter, a speaker according to a preferred embodiment of the present invention will be described with reference to the accompanying drawings. FIG. 2 is a sectional view of a speaker according to an embodiment of the present invention, and FIG. 3 is a perspective view of a weight ring according to an embodiment of the present invention.

As shown in the FIGS. 2 and 3, a speaker 100 of the present invention comprises a ring-shaped frame 110 having a through hole formed in the center thereof. A magnetic circuit section 120 is coupled to an outside of the frame 110 at the position of the through hole. The magnetic circuit section 120 comprises a yoke 121, a magnet 123 and a plate 125. The yoke 121 comprises a central portion formed to protrude in an upward direction. The magnet 123 and the plate 125 are sequentially stacked on the flange of the yoke 121 so that the central protrusion of the yoke 121 may extend through the central portion of the magnet 123 and the plate 125. Thus, the magnet 123 and the plate 125 result in being a ring-shape.

A vibrating section 130 is provided to an interior of the frame 110. The vibrating section 130 is vibrated by interaction with the magnetic circuit section 120, so the sound wave is generated from the vibrating section 130. The vibrating section 130 comprises a diaphragm 131, a voice coil 133 and a damper 135. An upper end of the diaphragm 131 is coupled to an upper side of the frame 110. The voice coil 133 has an upper end coupled to the diaphragm 131, and a lower end located between the outer surface of the protrusion of the yoke 121 and the inner surface of the plate 125. The voice coil 133 is vibrated in vertical directions by interaction with the magnetic circuit section 120 when a power is supplied externally. The damper 135 has an outer edge fixedly secured to the frame 110 and an inner edge secured to the outer side of the voice coil 133, for protecting the voice coil 133 from being moved to longitudinal directions when it vibrates in upward and downward directions.

A terminal 140 is provided in one side of the frame 110, for being connected with an external power. The terminal 140 is electrically connected to the voice coil 133 via the tinsel wire 145. A weight ring 150 is coupled to the voice coil 133. The weight ring 150 is vibrated by the vibration of the voice coil 133 to increase the amplitude of the voice coil 133 in a low frequency band. And also, the weight ring 150 protects the tinsel wire 145 from being contacted with the diaphragm 131 vibrated by the voice coil 133.

The weight ring 150 has a ring-shape coupling portion 151 and an extension portion 153. The coupling unit 151 is secured to the outer periphery of the voice coil 133. A plurality of the extension portion 153a and 153b are formed to extend from the both sides of the coupling portion 151. The extension portions 153 is formed to be symmetric with respect to a center of the coupling portion 151, so that the voice coil 133 is not to be eccentric but to be accurately vibrated in a vertical direction.

A connecting piece 155 is attached to the extension portion to which the tinsel wire 145 and the draw-out line 133a of the voice coil 133 are connected. The extension portion is located between the terminal 140 and the diaphragm 131 so as to face with the terminal 140. In this case, it is preferable that the extension portion 153a having the connecting piece 155 and a extension portion 153b not having the connecting piece 155 are similar in weight. Meanwhile, the tinsel wire 145 has one end connected to the terminal 140 and the other end connected to the connecting piece 155, so as to be located between the terminal 140 and the extension portion 153a having the connecting piece 155.

As configurations above described, the speaker of the present invention having the weight ring 150 allows the weight of the voice coil 133 to be increased. Thus when the voice coil 133 is vibrated, the amplitude of the voice coil 133 be increased. Accordingly, the voice coil 133 has a large amplitude in a low frequency band, and then the efficiency of the low-pitched sound range may be enhanced.

Furthermore, the tinsel wire 145 is not contacted with the diaphragm 131 when the diaphragm 131 is vibrated by the voice coil 133, since the tinsel wire 145 is located between the terminal 140 and the extension portion 153.

As described in detail above, the speaker according to the present invention comprises the weight ring coupled to the voice coil so as to increase the weight of the voice coil. Accordingly, the voice coil has a large amplitude in a low frequency band, thereby capable of enhancing the efficiency of the low-pitched sound range.

Also, the extension portion of the weight ring to which the tinsel wire is connected is located to face with the terminal between the terminal and the diaphragm, thereby prohibiting the tinsel wire 145 from being contacted with the diaphragm 131 although the diaphragm 131 is vibrated in the vertical direction.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A speaker comprising:
a ring-shaped frame having a through hole formed in the center of thereof;
a magnetic circuit section coupled to the outside of the through hole, for generating a magnetic force;
a vibrating section including a diaphragm with an upper end coupled to the inner side of the through hole at the upper side of the frame, and a voice coil having an upper end coupled to the diaphragm and a lower end located in the magnetic circuit section, for vibrating the diaphragm by interaction with the magnetic circuit section when a power is supplied;
a terminal formed to one side of the frame to be connected with an external power;
a tinsel wire having one end connected to the terminal and the other end connected to the voice coil, for providing the power from the external power to the voice coil; and
a weight ring coupled to the outer surface of the voice coil, for increasing an amplitude of the voice coil when the voice coil is vibrated, and for prohibiting the tinsel wire from contacting the diaphragm when the diaphragm is vibrated by the voice coil.

2. The speaker according to claim 1, wherein the weight ring have a ring-shaped coupling portion fixed to the outer surface of the voice coil, and a plurality of extended portions formed to extend outward from one side of the coupling unit and formed to be symmetric with respect to a center of the coupling unit;
One of the extended portions is located between the terminal and the diaphragm, and has connecting pieces for connecting the tinsel wire to the voice coil.
